(19) United States
(12) Patent Application Publication
(10) Pub. No.: US 2007/0201003 A1
(43) Pub. Date: Aug. 30, 2007

(54) IMAGING SYSTEM AND METHOD INCLUDING ADAPTIVE LIGHTING

(76) Inventor: David B. Rankin, (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/626,319

(22) Filed: Jan. 23, 2007

Related U.S. Application Data
(60) Provisional application No. 60/761,118, filed on Jan. 23, 2006.

(51) Int. Cl. G03B 31/02

(52) U.S. Cl. 352/29

(57) ABSTRACT

An imaging system and method are provided that include a lighting system having an array of light sources, a control system for driving one or more light sources to illuminate for a longer period of time than one or more other light sources, and an image sensor having a field of view for capturing an image of an object within the field of view. The light sources may be divided into annular bands with the control system causing an inner annular band of light sources to be driven to illuminate for a longer period of time than an outer annular band of light sources. Alternatively, the control system may be configured to drive one or more soft light sources to illuminate for a longer period of time than other light sources since the soft light sources produce less light output than the other light sources.

### CROSS REFERENCE TO RELATED APPLICATION(S)

The present application claims priority to U.S. Provisional Application No. 60/761,118, filed Jan. 23, 2006 entitled Imaging System and Method Including Adaptive Lighting, the contents of which are incorporated herein in their entirety.

### FIELD OF THE INVENTION

Embodiments of the present invention relate generally to techniques for measuring the launch conditions of a golf ball or other object in motion and, more particularly, to techniques for evenly illuminating a golf ball or other object such that accurate images can be obtained from which a variety of launch parameters can be determined.

### BACKGROUND OF THE INVENTION

Many golfers work consistently to improve their game. One tool that has been developed to assist golfers in analyzing their golf shots is a golf ball launch monitor. Golf ball launch monitors are used extensively to provide detailed information regarding the velocity of the ball, the launch angle of the ball, the side spin of the ball and the like. As such, golf ball launch monitors are quite useful in training sessions to evidence the manner in which swing changes affect the resulting golf shots. Similarly, launch monitors are quite useful in club fitting to provide feedback on the golf shots hit by a golfer with different clubs such that the golfer can more intelligently select the most suitable set of clubs for the game. Further details regarding launch monitors are provided by U.S. patent application Ser. No. 10/360,196 filed Feb. 7, 2003, entitled “Methods Apparatus and Computer Program Products for Processing Images of Golf Balls”, the contents of which are incorporated herein in their entirety.

Conventional launch monitors have utilized strobe lights for purposes of illuminating the object to be imaged. Moreover, strobe lights illuminate the foreground such that the background appears darker, thereby increasing the resolution of the object of interest. Strobe lights, however, can require a significant amount of power in order to appropriately illuminate the object. Moreover, the illumination of an object with a relatively few number of light sources tends to create hotspots. In this regard, hotspots are generally considered those portions of an image that are illuminated to a greater degree than other portions of the image, thereby resulting in generally uneven illumination of the object. As a result of the relatively uneven illumination of the object, the resulting measurements of the golf ball launch parameters are more difficult and the accuracy with which those parameters are determined may be sacrificed.

In an attempt to reduce the deleterious effects of hotspots within the field of view of an image sensor, diffusers can be utilized to create a random orientation of the light so as to more evenly illuminate the object. However diffusers add to the costs of the overall system and decrease the efficiency with which an object is illuminated.

As such, launch monitors having other sources of illumination have been considered. In this regard, arrays of light emitting diodes (LEDs) have been considered. While LED arrays may require less power than strobe lights and have many more sources of light, LEDs may also disadvantageously create hotspots in the field of view. Hotspots may be created by an LED array as a result of various inconsistencies. For example, some of the LEDs may provide more light output than other LEDs even though all of the LEDs are driven in the same manner. In this regard, the LEDs that produce less light output than the other LEDs are generally termed “soft LEDs.” Additionally, the portion of the object illuminated by the LEDs in the center of the array is generally illuminated to a greater degree than portions of the object illuminated by LEDs along the sides or edges of the array. In this regard, every portion of the field of view is generally illuminated by the combined effects of a plurality of different LEDs. However, those portions of the field of view that are principally illuminated by the LEDs along an edge of the LED array are generally not illuminated as greatly as those portions of the field of view that are illuminated by the central-most LEDs since the LEDs along with the sides of the array do not have as many neighboring LEDs to contribute to the cumulative illumination. This effect is commonly termed an “edge effect”.

If the LED array were infinite, there would not be hotspots attributable to edge effect. However, an infinite LED array is, of course, unworkable. However, if the LED array were twice as large as the field of view, the hotspots attributable to edge effects of the LED array would largely be imperceptible. However, the cost of an LED array that is two or more times the size of the field of view increases the cost of the imaging sensor. In addition, the power requirements required to drive an LED array that is at least two times the size of the field of view are also unnecessarily increased.

Accordingly, it would be desirable to provide an imaging system, such as for a launch monitor or the like, that utilizes a plurality of LEDs or other light sources as a source of illumination, but that reduces the deleterious effects of hotspots within the field of view.

### SUMMARY OF THE INVENTION

An imaging system and method are provided that address at least some of the issues associated with conventional imaging systems including, for example, the deleterious effect of hotspots within the field of view. For example, the imaging system and method may reduce the deleterious effect of hotspots attributable to edge effects and/or soft light sources, such as soft LEDs.

According to one aspect, an imaging system is provided that includes a lighting system comprising an array of light sources, a control system for actuating the lighting system such that one or more light sources are driven to illuminate for a longer period of time than one or more other light sources, and an image sensor, such as an accumulator-type imaging device, having a field of view for capturing an image of an object within the field of view while the lighting system illuminates at least a portion of the field of view. In one embodiment, the array of light sources is divided into a plurality of annular bands. As such, the control system can actuate the lighting system such that an inner annular band of light sources is driven to illuminate for a longer period of time than an outer annular band of light sources. While the annular bands may be of the same width, the array of light sources of one embodiment is configured such that at least one annular band has a smaller width than another annular band disposed therewithin. In another embodiment, the control system is configured to actuate the lighting system such that the one or more light sources that are driven to illuminate for a longer period of time are soft light sources that produce less light output than the one or more other light sources.

In one embodiment, the lighting system and the image sensor are configured such that the lighting system illuminates a region of the same size as the field of view of the image sensor. Additionally, the imaging system may include a triggering mechanism for providing a trigger signal to the control system for initiating actuation of the lighting system.

According to another aspect, a method is provided in which an array of light sources is actuated by driving one or more of the light sources to illuminate for a longer period of time than one or more other light sources. According to this method, an image of an object is then captured while the object is illuminated by the array of light sources, such as by capturing the image of the object with an accumulator-type imaging device. In some embodiments, a trigger signal may also be provide to initiate actuation of the array of light sources.

In embodiments in which the array of light sources is divided into a plurality of annular bands, the actuation of the array of light sources includes the actuation of the light sources such that an inner annular band of light sources is driven to illuminate for a longer period of time than an outer annular band of light sources. In other embodiments, the actuation of the light sources includes driving the soft light sources that produce less light output than the one or more other light sources to illuminate for a longer period of time than the other light sources.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of an imaging system according to one embodiment of the present invention; and

FIG. 2 is a representation of an LED array in which the LEDs are logically arranged into a plurality of annular bands according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

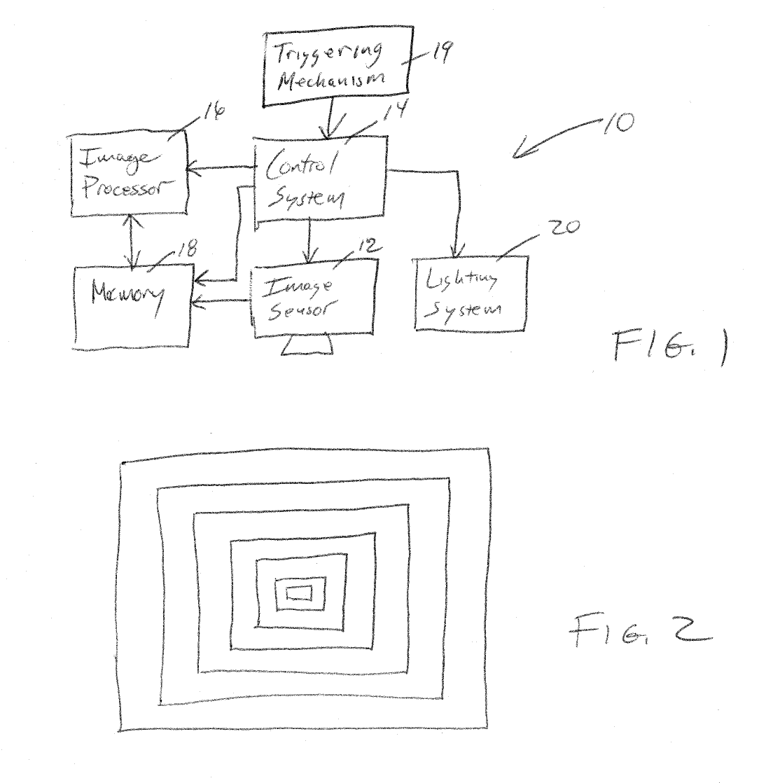

An imaging system 10 of one embodiment of the present invention is depicted in FIG. 1, such as for use in conjunction with a launch monitor. As described by the '196 application, the imaging system captures a pair of successive images of an object, such as a golf ball following its launch, in order to determine a number of parameters relating to the object, such as the velocity of the ball, launch angle of the ball, side spin of the ball and the like. Although the imaging system will be described as a launch monitor in conjunction with the capture of a pair of images of a golf ball at two different points in time following launch in order to determine various launch parameters, the imaging system can be utilized to capture successive images of a number of different objects including, for example, baseballs, softballs, tennis balls or the like, without departing from the spirit and scope of the present invention.

The imaging system 10 includes one or more image sensors 12. For example, the image sensor can be a single image sensor that obtains a double exposure image as described by the '196 application. Alternatively, the imaging system can include a pair of image sensors that are successively activated as described by U.S. Provisional Application No. 60/761,119, filed Jan. 23, 2006 and, in turn, by U.S. patent application Ser. No. ______, filed Jan. 23, 2007, both entitled “Imaging System and Method Including Multiple, Sequentially Exposed Image Sensors”. In either instance, the image sensor generally includes an accumulator-type imaging device, such as a CCD array, a CMOS imaging sensor or film-based photographic film. As known to those skilled in the art, an accumulator-type imaging device includes elements or pixels that receive photons while the shutter is open and that generate and accumulate electrons in response to the received photons with the electrons building up until the frame is moved out of the image sensor. The imaging system also includes a control system 14 for controlling the activation of the image system. The control system may include a microcontroller, microprocessor, personal computer or other computing system. The imaging system also includes an image processor 16 for processing the resulting image captured by the image sensor and stored in memory 18 such that the parameters associated with the object can be determined, such as in the manner described by the '196 application.

The imaging system 10 can be triggered and, as a result, can include a triggering mechanism 19, such as an optical trigger mechanism which detects movement of a golf club past a particular point or an audible trigger mechanism which detects the sound created upon contact between the golf club and the golf ball. The triggering mechanism provides a trigger signal to the control system 14 which directs the image sensor 12 to capture one or more images. In this regard, the control system can actuate the image sensor to capture an image at a first time and can then actuate either the same image sensor for a second time or a second image sensor to capture an image at a second time (later than the first time) in order to capture successive images of the golf ball following its launch.

As described herein, the imaging system 10 also includes a lighting system 20 that is typically activated by the control system 14 so as to illuminate the field of view of the image sensor 12 while the shutter of the image sensor is open, thereby permitting capture of an image of the object of interest of sufficient resolution for the subsequent analysis. According to the present invention, the lighting system is comprised of an array of LEDs, such as a generally rectangular array of LEDs, a generally circular array of LEDs or any other configuration of LEDs. Although the region that is illuminated by the LED array could be larger than the field of view of the image sensor in order to reduce the deleterious edge effects within the image, the LED array of one embodiment is sized and positioned such that the region illuminated by the LED array is of the same size as the field of view of the image sensor, thereby reducing the power requirement of the imaging sensor by avoiding any unnecessary illumination of regions outside the field of view of the image sensor. In this regard, the LED array may be configured such that the LEDs are angled toward one another such that the output of the LED array is focused upon a region that, in one advantageous embodiment, is substantially coincident with the field of view of the image sensor.

In order to reduce, if not prevent, hotspots within the field of view, such as attributable to edge effects, the individual LEDs are driven differently by the control system 14 so as to be turned on for different lengths of time (termed an “on-time”) such that the field of view is more evenly illuminated. In general terms, the LEDs in the center of the LED array have an on-time that is shorter than the LEDs about the edge of the LED array with the on-time of the respective LEDs being gradually increased from a minimum at the center of the LED array to a maximum at the edge of the LED array. While the on-time can be increased in a generally linear or other predefined manner in a direction from the center of the LED array to the edge of the LED array, the on-time of the respective LEDs can be increased in a more stairstep fashion in order to simplify the control necessary to drive the LED array. In this regard, annular bands or regions of LEDs can be defined, such as in the form of a set of nested picture frames, as shown in FIG. 2 with each LED within a respective band having the same on-time and with the on-time associated with each band increasing in a direction from the center of the LED array to the edge of the LED array. Although the annular bands may be defined in various manners, the annular bands of LEDs are defined in one embodiment to be evenly spaced as shown in FIG. 2, with the annular bands of LEDs being defined in another embodiment so as to decrease in width as the edge of the array is approached. Still further, the width of each band of LEDs generally involves a tradeoff between consistency of illumination and the requisite processing requirements with thinner bands typically providing more even illumination but requiring more processing resources and thicker bands providing less even illumination but needing fewer processing resources. Although all portions of a respective band may have the same width when measured in a radial direction, such as a width of one or more rows of pixels, a band may also be designed to have some portions, such as the vertically extending portions in the embodiment depicted in FIG. 2, that have a greater width than other portions, such as the horizontally extending portions in the embodiment depicted in FIG. 2.

The on-time for respective LEDs can be determined in various manners. In one embodiment, however, the on-time of each LED is adjusted until each portion of the field of view is equally illuminated or each portion of the field of view is illuminated to a level within a predefined range of acceptable illumination levels. Since the illumination of the edge portions of the field of view is generally provided by fewer LEDs than the illumination of the central portion of the field of view as a result of the LEDs along the edge of the LED array having fewer LED neighbors, the on-time for the LEDs about the edge of the array is generally greater than the on-time time for the LEDs near the center of the LED array in order to approximately equalize the illumination across the field of view. In instances in which the LED array is divided into a plurality of annular bands as shown in FIG. 2, for example, each band of LEDs can have an on-time that is longer than the on-time of the LEDs in bands interior thereof and shorter than the on-time of the LEDs in bands exterior thereof.

By providing relatively even illumination across the field of view, the resulting image captured by the image sensor 12 can more accurately represent the object of interest and, therefore, permit more accurate determination of the parameters associated with the movement of the object. Additionally, the imaging system 10 of embodiments of the present invention permit the field of view to be relatively evenly illuminated without the use of diffusers, thereby reducing capital costs associated with the imaging sensor and improving the efficiency with which the field of view is illuminated.

As noted above, another cause of hotspots within a field of view is attributable to soft LEDs, that is, LEDs that do not provide as much light output as other LEDs even though the LEDs are driven in the same manner. In order to address the hotspots created by an LED array that includes at least some soft LEDs, the soft LEDs can be identified and then driven differently by the control system 14 than the other LEDs in order to provide the same amount of illumination. In order to identify the soft LEDs, a gray card could be placed in the field of view. As known to those skilled in the art, a gray card has a consistent gray color across the field of view. By illuminating the field of view and capturing an image of the gray card, the image processor 16 can analyze the resulting image with any variation in the image attributable to differences in the illumination occasioned by soft LEDs since the resulting image would otherwise be consistently gray across the entire image in response to even illumination. By determining which portions of the resulting image are not sufficiently illuminated and thereby appear to be darker than other portions of the image, the soft LEDs can be identified. The soft LEDs can then be driven so as to have a longer on-time and another image of the gray card captured. Depending upon the change in the resulting image attributable to the change in the on-time associated with the soft LEDs the on-time for the soft LEDs can be further adjusted, either upwardly or downwardly, and images of the gray card repeatedly captured until the resulting image is evenly illuminated across the entire field of view. As a result, the imaging system 10 of one embodiment of the present invention can account for differences in illumination attributable to soft LEDs and can adjust the on-time of those soft LEDs to reduce, if not eliminate, hotspots attributable to the soft LEDs.

An improved imaging system 10 is therefore provided that includes a source of illumination, such as an LED array, that is controllably driven such that the on-time of the respective LEDs is adjusted in order to provide smooth and even illumination across the field of view, thereby reducing, if not eliminating, hotspots within the image. As a result, the resulting image provides a more true representation of the object and permits various parameters associated with the movement of the object to be determined in a more accurate manner.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An imaging system comprising:
a lighting system comprising an array of light sources;
a control system for actuating the lighting system such that the light sources in a medial portion of the array are driven to illuminate for a longer period of time than the light sources proximate an edge of the array; and
an image sensor having a field of view for capturing an image of an object within the field of view while the lighting system illuminates at least a portion of the field of view.

2. An imaging system according to claim 1 wherein the array of light sources is divided into a plurality of annular bands, and wherein the control system is configured to actuate the lighting system such that an inner annular band of light sources is driven to illuminate for a longer period of time than an outer annular band of light sources.

3. An imaging system according to claim 2 wherein at least one annular band has a smaller width than another annular band disposed therewithin.

4. An imaging system according to claim 1 wherein said image sensor comprises an accumulator-type imaging device.

5. An imaging system according to claim 1 wherein the lighting system and the image sensor are configured such that the lighting system illuminates a region of the same size as the field of view of the image sensor.

6. An imaging system according to claim 1 further comprising a triggering mechanism for providing a trigger signal to the control system for initiating actuation of the lighting system.

7. An imaging system comprising:
a lighting system comprising an array of light sources;
a control system for actuating the lighting system such that one or more light sources are driven to illuminate for a longer period of time than one or more other light sources; and
an image sensor having a field of view for capturing an image of an object within the field of view while the lighting system illuminates at least a portion of the field of view.

8. An imaging system according to claim 7 wherein the array of light sources is divided into a plurality of annular bands, and wherein the control system is configured to actuate the lighting system such that an inner annular band of light sources is driven to illuminate for a longer period of time than an outer annular band of light sources.

9. An imaging system according to claim 8 wherein at least one annular band has a smaller width than another annular band disposed therewithin.

10. An imaging system according to claim 7 wherein the one or more light sources that are driven to illuminate for a longer period of time are soft light sources that produce less light output than the one or more other light sources.

11. An imaging system according to claim 7 wherein said image sensor comprises an accumulator-type imaging device.

12. An imaging system according to claim 7 wherein the lighting system and the image sensor are configured such that the lighting system illuminates a region of the same size as the field of view of the image sensor.

13. An imaging system according to claim 7 further comprising a triggering mechanism for providing a trigger signal to the control system for initiating actuation of the lighting system.

14. A method comprising:
actuating an array of light sources, wherein actuating the array of light sources comprises driving one or more of the light sources to illuminate for a longer period of time than one or more other light sources; and
capturing an image of an object while the object is illuminated by the array of light sources.

15. A method according to claim 14 wherein the array of light sources is divided into a plurality of annular bands, and wherein actuating the array of light sources comprises actuating the light sources such that an inner annular band of light sources is driven to illuminate for a longer period of time than an outer annular band of light sources.

16. A method according to claim 15 wherein at least one annular band has a smaller width than another annular band disposed therewithin.

17. A method according to claim 14 wherein the one or more light sources that are driven to illuminate for a longer period of time are soft light sources that produce less light output than the one or more other light sources.

18. A method according to claim 14 wherein capturing the image of the object comprises capturing the image of the object with an accumulator-type imaging device.

19. A method according to claim 14 further comprising providing a trigger signal to initiate actuation of the array of light sources.
